(19) United States
(12) Patent Application Publication
(10) Pub. No.: US 2026/0341037 A1
(43) Pub. Date: Oct. 29, 2026

(54) ANOMALY CLASSIFICATION IN IMAGING SENSOR DATA

(71) Applicant: Ford Global Technologies, LLC, Dearborn, MI (US)

(72) Inventors: Ali Hassani, Ann Arbor, MI (US); Robert Schroeter, Livonia, MI (US)

(73) Assignee: Ford Global Technologies, LLC, Dearborn, MI (US)

(21) Appl. No.: 19/192,435

(22) Filed: Apr. 29, 2025

(51) Int. Cl. G06V 20/58; G06V 10/764; G06V 10/774; G06V 10/98

(52) U.S. Cl. CPC G06V 20/58; G06V 10/764; G06V 10/774; G06V 10/993

(57) ABSTRACT

A computer includes a processor and a memory, and the memory stores instructions executable by the processor to generate an anomaly map by executing a first machine-learning program, the first machine-learning program taking sensor data from an imaging sensor as input; and classify an anomaly in the sensor data as a specific type by executing a second machine-learning program. The anomaly map includes a set of likelihood values at respective pixel locations. Each likelihood value represents a probability that an anomaly of any type is present at the respective pixel location. The second machine-learning program takes the anomaly map as input.

### BACKGROUND

Vehicles typically include a variety of sensors. The sensors may provide data about operation of the vehicle, for example, wheel speed, wheel orientation, and engine and transmission data (e.g., temperature, fuel consumption, etc.). The sensors may detect the location and/or orientation of the vehicle. The sensors can include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors may detect the external world, including objects and/or characteristics of surroundings of the vehicle, such as other vehicles, road lane markings, traffic lights and/or signs, road users, etc. The sensors can include radar sensors, ultrasonic sensors, scanning laser range finders, light detection and ranging (lidar) devices, and image processing sensors such as cameras.

### BRIEF DESCRIPTION OF THE DRAWINGS

FIG. 1 is a block diagram of an example vehicle.

FIG. 2 is a rear view from an interior of the vehicle through a windshield of the vehicle.

FIG. 3 is a diagram of an example machine-learning architecture installed on the vehicle for classifying anomalies.

FIG. 4 is a flowchart of an example process for classifying the anomalies and actuating the vehicle.

### DETAILED DESCRIPTION

This disclosure describes techniques for classifying anomalies in sensor data from an imaging sensor. For example, the imaging sensor may be a camera mounted to a vehicle, the sensor data may be an image, and the anomalies may be types of occlusions such as rain, fog, debris on the camera lens, etc. Classifying an anomaly can help mitigate the anomaly. For example, a component of the vehicle may be actuated based on the classification, such as windshield wipers in response to rain, a cleaning nozzle in response to debris on the camera lens, etc.

A computer is programmed to generate an anomaly map by executing a first machine-learning program and classify an anomaly in the sensor data as a specific type by executing a second machine-learning program. The first machine-learning program takes the sensor data from the imaging sensor as input, and the second machine-learning program takes the anomaly map as input. The anomaly map includes a set of likelihood values at respective pixel locations. Each likelihood value represents a probability that an anomaly of any type is present at the respective pixel location. In other words, the anomaly map does not indicate which type of anomaly is present; instead, the probabilities are for a binary outcome, that is, whether or not any type of anomaly is present. Because the probabilities are associated with pixel locations, the anomaly map also indicates where in the field of view of the imaging sensor the anomalies are located. Once the first machine-learning program generates the anomaly map, the second machine-learning program uses the anomaly map to classify the anomalies in the sensor data as specific types.

The use of this style of anomaly map provides some advantages. Compared with multiple networks that each identify a single type of anomaly, the current disclosure is more computationally efficient. Compared with both a single-stage classifier and multiple networks, the current disclosure uses less training data, reducing both computational effort during training as well as labelling effort. The current disclosure helps robustness of the output by capturing common elements of multiple types of occlusions in the first machine-learning program. It can be easier to train the two-stage classifier to a high degree of accuracy because the detection stage and the classification stage can be separately fine-tuned.

A computer includes a processor and a memory, and the memory stores instructions executable by the processor to generate an anomaly map by executing a first machine-learning program, the first machine-learning program taking sensor data from an imaging sensor as input; and classify an anomaly in the sensor data as a specific type by executing a second machine-learning program. The anomaly map includes a set of likelihood values at respective pixel locations. Each likelihood value represents a probability that an anomaly of any type is present at the respective pixel location. The second machine-learning program takes the anomaly map as input.

In an example, the imaging sensor may be mounted to a vehicle, and the instructions may further include instructions to actuate a component of the vehicle based on the specific type of the anomaly.

In an example, the imaging sensor may be mounted to a vehicle, and the instructions may further include instructions to actuate a component of the vehicle based on a location of the anomaly as indicated by the anomaly map.

In an example, the first machine-learning program may be trained on a set of training sensor data with binary labels indicating whether an anomaly is present or absent. In a further example, each binary label may apply to the respective training sensor data recorded at a specific timestep as a whole.

In another further example, the set of training sensor data may be a first set of first training sensor data, and the first machine-learning program may be trained on a second set of second training sensor data with labels indicating pixel locations of anomalies. In a yet further example, the first set may be a majority of training data used to train the first machine-learning program.

In an example, the instructions to classify the anomaly may include instructions to select the specific type from a predetermined set of potential specific types. In a further example, each likelihood value in the anomaly map may represent the probability that an anomaly of at least one of the potential specific types is present at the respective pixel location.

In another further example, the potential specific types may be types of occlusions.

In another further example, an output of the second machine-learning program may be an anomaly-type map, the anomaly-type map including a set of likelihood vectors at respective pixel locations, each likelihood vector including a plurality of entries, each entry representing a probability that an anomaly of one of the respective potential specific types is present at the respective pixel location.

In an example, the instructions may further include instructions to determine an anomaly score for the anomaly map, and, in response to the anomaly score exceeding a threshold, classify the anomaly as the specific type by executing the second machine-learning program.

In an example, the first machine-learning program may include a fully convolutional data description.

In an example, the first machine-learning program may include at least one up-sampling layer.

In an example, the imaging sensor may be a camera, and the sensor data may be an image.

A method includes generating an anomaly map by executing a first machine-learning program, the first machine-learning program taking sensor data from an imaging sensor as input; and classifying an anomaly in the sensor data as a specific type by executing a second machine-learning program. The anomaly map includes a set of likelihood values at respective pixel locations. Each likelihood value represents a probability that an anomaly of any type is present at the respective pixel location. The second machine-learning program takes the anomaly map as input.

In an example, the imaging sensor may be mounted to a vehicle, and the method may further include actuating a component of the vehicle based on at least one of the specific type of the anomaly or a location of the anomaly as indicated by the anomaly map.

In an example, the first machine-learning program may be trained on a set of training sensor data with binary labels indicating whether an anomaly is present or absent.

In an example, classifying the anomaly may include selecting the specific type from a predetermined set of potential specific types, an output of the second machine-learning program may be an anomaly-type map, the anomaly-type map including a set of likelihood vectors at respective pixel locations, each likelihood vector including a plurality of entries, each entry representing a probability that an anomaly of one of the respective potential specific types is present at the respective pixel location.

In an example, the first machine-learning program may include a fully convolutional data description followed by at least one up-sampling layer.

With reference to the Figures, wherein like numerals indicate like parts throughout the several views, a computer 105 includes a processor and a memory, and the memory stores instructions executable by the processor to generate an anomaly map 305 by executing a first machine-learning program 310, the first machine-learning program 310 taking sensor data 315 from an imaging sensor 110 as input; and classify an anomaly 205 in the sensor data 315 as a specific type by executing a second machine-learning program 320. The anomaly map 305 includes a set of likelihood values at respective pixel locations. Each likelihood value represents a probability that an anomaly 205 of any type is present at the respective pixel location. The second machine-learning program 320 takes the anomaly map 305 as input.

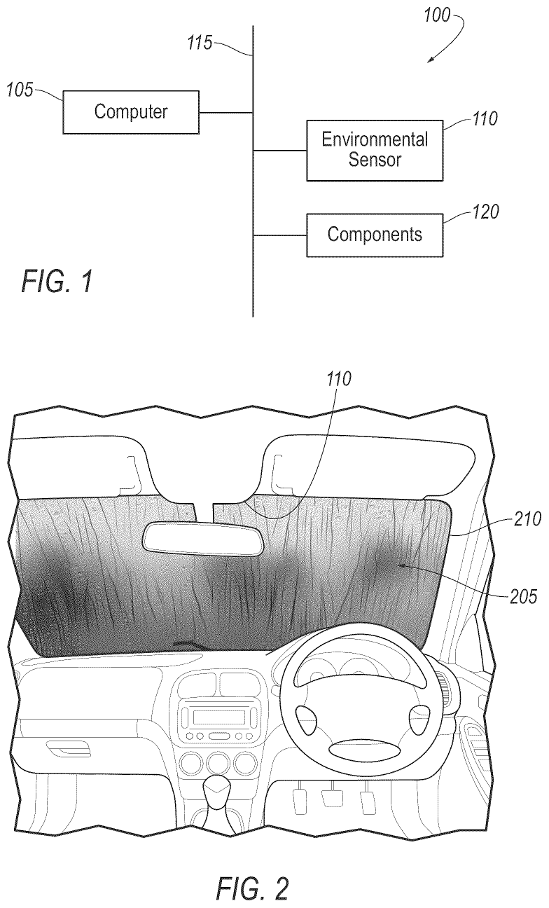

With reference to FIG. 1, a vehicle 100 may be any passenger or commercial automobile such as a car, a truck, a sport utility vehicle, a crossover, a van, a minivan, a taxi, a bus, etc. Alternatively, the vehicle 100 may be a different mode of transportation such as a boat, train, airplane, helicopter, flying taxi, unmanned aerial vehicle (UAV) (e.g., a drone), etc. The vehicle 100 may include the computer 105, a communications network 115, the imaging sensor 110, and at least one actuatable component 120.

The computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 115. The communications network 115 may be a controller area network (CAN) bus, Ethernet, WiFi, Local Interconnect Network (LIN), onboard diagnostics connector (OBD-II), and/or any other wired or wireless communications network. The computer 105 may be communicatively coupled to the imaging sensor 110, the actuatable components 120, and other components via the communications network 115.

The imaging sensor 110 detects the external world, including objects and/or characteristics of surroundings of the vehicle 100, such as other vehicles, road lane markings, traffic lights and/or signs, road users, etc. For example, the imaging sensor 110 may be a camera, a radar sensor, a light detection and ranging (lidar) device, an ultrasonic sensor, etc. For example, the imaging sensor 110 can be a camera and can detect electromagnetic radiation in some range of wavelengths. For example, the camera may detect visible light, infrared radiation, ultraviolet light, or some range of wavelengths including visible, infrared, and/or ultraviolet light. For example, the camera can be a charge-coupled device (CCD), complementary metal oxide semiconductor (CMOS), or any other suitable type. For another example, the imaging sensor 110 can be a radar. The radar transmits radio waves and receives reflections of those radio waves to detect physical objects in the environment. The radar can use direct propagation (i.e., measuring time delays between transmission and reception of radio waves) and/or indirect propagation (i.e., Frequency Modulated Continuous Wave (FMCW) method, that is, measuring changes in frequency between transmitted and received radio waves). For another example, the imaging sensor 110 may be a lidar device. A lidar device detects distances to objects by emitting laser pulses at a particular wavelength and measuring the time of flight for the pulse to travel to the object and back. The lidar device can be any suitable type for providing the lidar data on which the computer 105 can act, such as spindle-type lidar, solid-state lidar, flash lidar, etc. For another example, the imaging sensor 110 may be an ultrasonic sensor. An ultrasonic sensor measures distances to features of the environment by emitting ultrasonic sound waves and converting the reflected sound into an electrical signal. The imaging sensor 110 is mounted to the vehicle 100. The imaging sensor 110 may thus be provided with a field of view of a portion of the surroundings of the vehicle 100.

The components 120 are parts of the vehicle 100 that are capable of being actuated according to an instruction from the computer 105 via the communications network 115. In the context of the present disclosure, “actuating” is defined as setting an object into motion or action via a mechanical or electromechanical stimulus. For example, the components 120 may include windshield wipers, headlamps, pumps and/or valves for providing washer fluid or pressurized airflow to a windshield 210 or to the imaging sensor 110, etc.

With reference to FIG. 2, an anomaly 205 is something in the field of view of the imaging sensor 110 that obstructs or degrades an ability of the imaging sensor 110 to detect objects and features of the environment surrounding the vehicle 100. The anomaly 205 is “anomalous” in that the anomaly 205 is a deviation from a depiction of the environment surrounding the vehicle 100. The anomaly 205 may either be something physically attached to the vehicle 100 (e.g., a bug or dirt on the imaging sensor 110 or the windshield 210), or a nonsolid feature of the environment through which the vehicle 100 could navigate (e.g., rain, snow, fog, etc.). For example, the anomaly 205 may be an occlusion (i.e., something blocks a field of view of the imaging sensor 110). The anomaly 205 is not an object or environmental feature that the vehicle 100 would navigate around.

The computer 105 may store a predetermined set of potential specific types of anomalies 205. The potential specific types may be types of occlusions. For example, the potential specific types may include rain in the environment, fog in the environment, snow in the environment, water on the imaging sensor 110 or windshield 210, dirt on the imaging sensor 110 or windshield 210, a bug on the imaging sensor 110 or windshield 210, etc. The predetermined set may include multiple of these potential specific types. The potential specific types in the predetermined set may be chosen to have visually different appearances and to be addressable by different interventions.

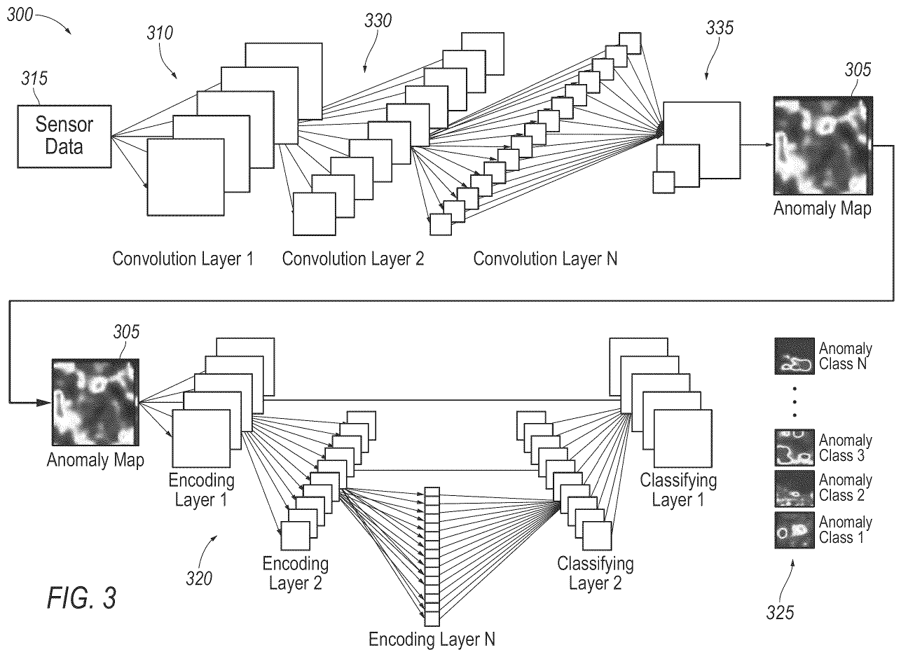

With reference to FIG. 3, the computer 105 may store a machine-learning architecture 300 and may be programmed to execute the machine-learning architecture 300. As a general overview, the machine-learning architecture 300 includes the first machine-learning program 310 and the second machine-learning program 320. The first machine-learning program 310 takes the sensor data 315 from the imaging sensor 110 as input, and the first machine-learning program 310 generates the anomaly map 305 as output. The execution of the second machine-learning program 320 may be conditional on detecting at least one anomaly 205 according to the anomaly map 305. The second machine-learning program 320 takes the anomaly map 305 as input, and the second machine-learning program 320 classifies any anomalies 205 in the sensor data 315 as output. For example, the second machine-learning program 320 generates an anomaly-type map 325 as output.

The sensor data 315 is generated by the imaging sensor 110. For example, the sensor data 315 may be an image from a camera or range data from a radar sensor, lidar device, or ultrasonic sensor. The computer 105 may be programmed to receive the sensor data 315 from the imaging sensor 110 (e.g., over the communications network 115).

Each image is a two-dimensional matrix of pixels. Each pixel has a brightness or color represented as one or more numerical values, such as a scalar unitless value of photometric light intensity between 0 (black) and 1 (white), or values for each of red, green, and blue (e.g., each on an 8-bit scale (0 to 255) or a 12- or 16-bit scale). The pixels may be a mix of representations (e.g., a repeating pattern of scalar values of intensity for three pixels and a fourth pixel with three numerical color values, or some other pattern). Position in an image frame (i.e., position in the field of view of the imaging sensor 110 at the time that the image frame was recorded) can be specified in pixel dimensions or coordinates (e.g., an ordered pair of pixel distances), such as a number of pixels from a top edge and a number of pixels from a left edge of the image frame.

The range data may be, for example, a point cloud. The points of the point cloud specify respective positions in the environment relative to the position of the ranging sensor. For example, the range data can be in spherical coordinates with the ranging sensor at the origin of the spherical coordinate system. The spherical coordinates can include a radial distance (i.e., a measured depth from the ranging sensor to the point measured by the ranging sensor); a polar angle (i.e., an angle from a vertical axis through the ranging sensor to the point measured by the ranging sensor); and an azimuthal angle (i.e., an angle in a horizontal plane from a horizontal axis through the ranging sensor to the point measured by the ranging sensor). The horizontal axis can be, for example, along a vehicle-forward direction. Alternatively, the ranging sensor can return the points as Cartesian coordinates with the ranging sensor at the origin or as coordinates in any other suitable coordinate system, or the computer 105 can convert the spherical coordinates to Cartesian coordinates or another coordinate system after receiving the range data.

The sensor data 315 is time-series data. As will be generally understood, and for purposes of this disclosure, time-series data are data samples at discrete successive timesteps. In this disclosure, the data samples may be images (i.e., one image at each timestep) or point clouds (i.e., one point cloud at each timestep).

The computer 105 is programmed to generate the anomaly map 305 by executing the first machine-learning program 310. The first machine-learning program 310 takes the sensor data 315 from the imaging sensor 110 as input. The first machine-learning program 310 generates the anomaly map 305 as output. For example, the first machine-learning program 310 may take an image or a point cloud as input, and the machine-learning program may generate the anomaly map 305 corresponding to the image or point cloud. The first machine-learning program 310 may successively generate anomaly maps 305 at each timestep as images or point clouds are received.

The anomaly map 305 includes a set of likelihood values at respective pixel locations. For example, the anomaly map 305 may include a likelihood value at each pixel location in an image or point cloud of the sensor data 315, meaning that the anomaly map 305 has the same size (e.g., pixel height and pixel width) as the image or point cloud. Alternatively, the anomaly map 305 may include likelihood values associated with respective regions, with each region encompassing a range of pixel values surrounding a pixel location, meaning that the anomaly map 305 is down-sampled from the image or point cloud.

Each likelihood value represents a probability that an anomaly 205 of any type is present at the respective pixel location. The probability represented by the likelihood value (i.e., whether an anomaly 205 is present) reflects an underlying binary random variable. The binary random variable is “underlying” in that the binary random variable is not itself part of the anomaly map 305. For example, a value of 1 for the binary random variable may indicate that an anomaly 205 is present at the pixel location, and a value of 0 may indicate that no anomaly 205 is present at the pixel location. The likelihood value (which is part of the anomaly map 305) indicates the probability that the binary random variable is 1. The likelihood value may take any value from 0 to 1 (e.g., the likelihood value may be stored in the memory as a floating-point number). More specifically, each likelihood value in the anomaly map 305 may represent the probability that an anomaly 205 of at least one of the potential specific types is present at the respective pixel location. The binary random variable may represent whether an anomaly 205 of at least one of the potential specific types is present at the pixel location (regardless of which of the potential specific types).

The first machine-learning program 310 may be any suitable machine-learning algorithm for single-class classification tied to locations in the input data. For example, the first machine-learning program 310 may include a fully convolutional data description 330. A fully convolutional data description 330 is a neural network using convolutional and pooling layers (but not fully connected layers). The convolutional layers and the pooling layers may be alternated, with each layer outputting to the other type of layer. This structure preserves data related to pixel location.

The first machine-learning program 310 may further include at least one up-sampling layer 335 (e.g., the fully convolutional data description 330 followed by the at least one up-sampling layer 335). The fully convolutional data description 330 outputs a preliminary anomaly map with dimensions smaller than the image or point cloud inputted to the fully convolutional data description 330. The up-sampling layers 335 may output the anomaly map 305 with the same dimensions as the inputted sensor data 315. For example, the up-sampling layer 335 may include any suitable algorithm for increasing the resolution while maintaining spatial data, such as atrous convolution, up-sampling via skip connection layer, or strided transposed convolution.

The first machine-learning program 310 is trained on a first set X1 of first training sensor data and possibly a second set X2 of second training sensor data. The first set of first training sensor data includes a collection of data samples X1₁, . . . , X1ₙ of the same kind as the input data for the first machine-learning program 310 (e.g., images or point clouds). The first training sensor data includes binary labels y1₁, . . . , y1ₙ indicating whether an anomaly 205 is present or absent (i.e., ground truth). Each binary label applies to the respective training sensor data recorded at a specific timestep as a whole (e.g., to an image as a whole or to a point cloud as a whole), in other words, for data sample X1ᵢ, the label y1ᵢ=0 indicates no anomaly 205 and y1ᵢ=1 indicates an anomaly 205, in which i is an index of the timesteps running from 1 to n. The first set may be chosen to encompass data samples of all the potential specific types of anomalies 205 and the absence of any types of anomalies 205.

The second set of second training sensor data includes a collection of data samples X2₁, . . . , X2ₙ of the same kind as the input data for the first machine-learning program 310 (e.g., images or point clouds). The second training data includes labels indicating pixel locations of anomalies 205. For example, each label y2ᵢ may indicate whether an anomaly 205 is present at a corresponding pixel location; in other words, y2ᵢ=(0, u, v) indicates no anomaly 205 at pixel coordinates (u, v) at timestep i, and y2ᵢ=(1, u, v) indicates an anomaly 205 at pixel coordinates (u, v) at timestep i. The first set may be a majority of training data used to train the first machine-learning program 310. For example, the number of data samples in the first set X1 may be multiple orders of magnitude greater than the number of samples in the second set X2 (e.g., 2,000,000 versus 50,000). The first set is significantly less labor-intensive to create, and a relatively small number of samples in the second set is sufficient to increase the accuracy of the output.

The first machine-learning program 310 (e.g., the fully convolutional data description 330) may be trained by any suitable training algorithm, such as backpropagation with an optimization algorithm such as gradient descent applied to an objective function. For example, the objective function may be a pseudo-Huber loss, as given in the following expression:

$$ℒ = {min}_{W} \frac{1}{n} {\sum }_{i = 1}^{n} ( 1 - {y}_{i} ) \frac{1}{u \cdot v} {‖ A ( {X}_{i} ) ‖}_{1} - {y}_{i} log ( 1 - exp ( - \frac{1}{u \cdot v} {‖ A ( {X}_{i} ) ‖}_{1} ) )$$

in which W is the set of weights for the first machine-learning program 310 φ(X; W), X is the set of training sensor data, A(X) is an output matrix for the first machine-learning program 310 φ(X; W), u and v are the pixel height and width of the preliminary anomaly map (before up-sampling), and ∥A(X)∥₁ is the sum of the entries of the output matrix A(X). The output matrix is given by the following expression:

A(X)=\sqrt{φ(X;W)²+1}−1

The computer 105 may be programmed to determine whether at least one anomaly 205 was detected in the data sample. For example, the computer 105 may be programmed to determine an anomaly score for the anomaly map 305. The anomaly score may be representative of an overall likelihood that the data sample (e.g., image or point cloud) includes at least one anomaly 205. For example, the anomaly score may be a sum of the likelihood values of the data sample (i.e., a sum of the likelihood values in a single image or point cloud). The computer 105 may be further programmed to determine whether the anomaly score exceeds a threshold. The threshold may be chosen to indicate that an anomaly 205 is probably present.

Execution of the second machine-learning program 320 may be conditional on the anomaly score exceeding the threshold. For example, the computer 105 may be programmed to, in response to the anomaly score exceeding the threshold, classify the anomaly 205 as the specific type by executing the second machine-learning program 320, as described below. The computer 105 may be programmed to, in response to the anomaly score being below the threshold, refrain from executing the second machine-learning program 320 (e.g., during that timestep or until the first machine-learning program 310 has executed again).

The computer 105 is programmed to classify an anomaly 205 in the sensor data 315 as a specific type by executing the second machine-learning program 320. The second machine-learning program 320 takes the anomaly map 305 as input. The second machine-learning program 320 classifies any anomalies 205 in the sensor data 315 as output. For example, the second machine-learning program 320 generates the anomaly-type map 325 as output. The second machine-learning program 320 may successively generate anomaly-type maps 325 at each timestep as the anomaly maps 305 are received.

The anomaly-type map 325 includes a set of likelihood vectors at respective pixel locations. For example, the anomaly-type map 325 may include a likelihood vector at each pixel location in the anomaly map 305, meaning that the anomaly-type map 325 has the same size (e.g., pixel height and pixel width) as the anomaly map 305, which may be the same dimensions or smaller than the image.

Each likelihood vector includes a plurality of entries. Each entry represents a probability that an anomaly 205 of one of the respective potential specific types is present at the respective pixel location. For example, if the predetermined set of potential specific types includes six types, then the likelihood vectors each have six entries, one for each potential specific type. In other words, the anomaly-type map 325 has a channel for each entry in the likelihood vectors (e.g., in this example, six), shown as separate maps in FIG. 3. Whether an anomaly 205 of each potential specific type is present is a binary random variable. For example, a value of 1 for the binary random variable may indicate that that type of anomaly 205 is present at the pixel location, and a value of 0 may indicate that that type of anomaly 205 is not present at the pixel location (although a different potential specific type may be present). The value for each entry in the likelihood vector indicates the probability that the respective binary random variable is 1. The values for the entries may take any value from 0 to 1.

The second machine-learning program 320 may be any suitable algorithm to select the specific type from the predetermined set of potential specific types. For example, the computer 105 may execute a semantic segmentation algorithm. A semantic segmentation algorithm labels each pixel in an image with a classification, for example, by determining probabilities for each potential specific type in the predetermined set and selecting the potential specific type with the highest probability. Types of semantic segmentation algorithms include a U-net (as shown in FIG. 3), a deep neural network, a convolutional neural network, etc.

The second machine-learning program 320 is trained on a set of training data including anomaly maps paired with ground-truth anomaly-type maps. A ground-truth anomaly-type map may be efficiently created by applying each potential specific type of anomaly 205 that is present at any location in the image frame across the entire ground-truth anomaly-type map (e.g., (0, 0, 1, 1, 0, 0) for all pixel locations if the third and fourth potential specific types are present), and then applying a mask over the pixel locations with no anomalies 205 according to the corresponding anomaly map (e.g., setting the masked pixel locations to (0, 0, 0, 0, 0, 0)).

The second machine-learning program 320 may be trained by any suitable training algorithm, such as backpropagation with an optimization algorithm such as gradient descent applied to an objective function. For example, the objective function may be an L2 loss.

The computer 105 may be programmed to actuate a component 120 based on the output of the machine-learning architecture 300. As one example, the computer 105 may actuate the component 120 of the vehicle 100 based on the specific type of the anomaly 205 (e.g., as indicated by the anomaly-type map 325). For example, the computer 105 may actuate the windshield wipers in response to the specific type being rain. For example, the computer 105 may actuate the climate-control system to blow hot air across the windshield 210 in response to the specific type being snow in the environment or ice on the windshield 210. For example, the computer 105 may actuate an air nozzle aimed at the imaging sensor 110 in response to the specific type being a bug on the imaging sensor 110. For example, the computer 105 may actuate a pump or valve controlling washer fluid to a fluid nozzle in response to the specific type being dirt or dust on the imaging sensor 110.

Alternatively or additionally, the computer 105 may actuate the component 120 of the vehicle 100 based on a location of the anomaly 205 as indicated by the anomaly map 305. The location of the anomaly 205 indicated in the anomaly map 305 may be carried over to the anomaly-type map 325. For example, the computer 105 may select one or a subset of nozzles to actuate from multiple nozzles aimed at the imaging sensor 110 based on the pixel location of the anomaly 205 that is on the imaging sensor 110. For example, the computer 105 may actuate the windshield wipers at a slower or less frequent speed in response to the anomaly 205 covering a portion of the windshield 210 and at a faster or more frequent speed in response to the anomaly 205 covering all of the windshield 210.

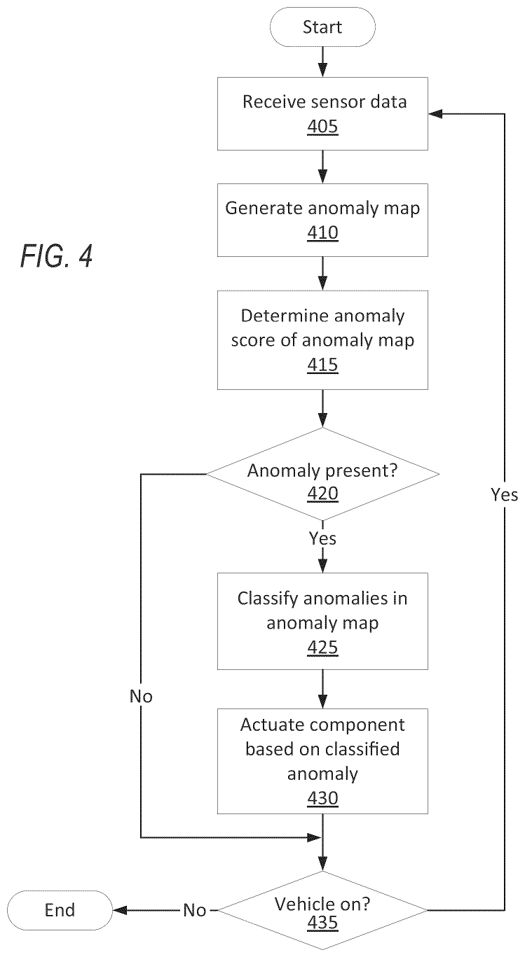

FIG. 4 is a flowchart illustrating an example process 400 for classifying anomalies 205 and actuating the components 120. The memory of the computer 105 stores executable instructions for performing the steps of the process 400 and/or programming can be implemented in structures such as mentioned above. As a general overview of the process 400, the computer 105 receives the sensor data 315, generates the anomaly map 305, and determines the anomaly score of the anomaly map 305. In response to an anomaly 205 being present, the computer 105 classifies the anomalies 205 in the anomaly map 305 and actuates the component 120. The process 400 continues for as long as the vehicle 100 remains on.

The process 400 begins in a block 405, in which the computer 105 receives the sensor data 315 from the imaging sensor 110, as described above.

Next, in a block 410, the computer 105 generates the anomaly map 305 by executing the first machine-learning program 310, as described above.

Next, in a block 415, the computer 105 determines the anomaly score for the anomaly map 305, as described above.

Next, in a decision block 420, the computer 105 determines whether an anomaly 205 is present by determining whether the anomaly score exceeds the threshold, as described above. In response to the anomaly score exceeding the threshold, the process 400 proceeds to a block 425. In response to the anomaly score being below the threshold, the process 400 proceeds to a decision block 435.

In the block 425, the computer 105 classifies the anomaly 205 in the sensor data 315 as a specific type by executing the second machine-learning program 320, resulting in the anomaly-type map 325, as described above.

Next, in a block 430, the computer 105 actuates the component 120 of the vehicle 100 based on at least one of the specific type of the anomaly 205 or the location of the anomaly 205 as indicated by the anomaly map 305, as described above. After the block 430, the process 400 proceeds to the decision block 435.

In the decision block 435, the computer 105 determines whether the vehicle 100 is on (i.e., is in an on state). For the purposes of this disclosure, “on state” is defined as the state of the vehicle 100 in which full electrical energy is provided to electrical components of the vehicle 100 and the vehicle 100 is ready to be driven (e.g., the engine is running); “off state” is defined as the state of the vehicle 100 in which a low amount of electrical energy is provided to selected electrical components of the vehicle 100, typically used when the vehicle 100 is being stored; and “accessory-power state” is defined as the state of the vehicle 100 in which full electrical energy is provided to more electrical components than in the off state and the vehicle 100 is not ready to be driven. Typically, an operator puts the vehicle 100 into the on state when the operator is going to operate the vehicle 100, puts the vehicle 100 into the off state when the operator is going to leave the vehicle 100, and puts the vehicle 100 into the accessory-power state when the operator is going to sit in but not operate the vehicle 100. In response to the vehicle 100 being in the on state, the process 400 returns to the block 405 to continue receiving the sensor data 315. In response to the vehicle 100 transitioning to the off state or accessory-power state, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

The disclosure has been described in an illustrative manner, and it is to be understood that the terminology which has been used is intended to be in the nature of words of description rather than of limitation. Use of “in response to,” “upon determining,” etc. indicates a causal relationship, not merely a temporal relationship. The adjectives “first,” “second,” “third,” and “fourth” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
generate an anomaly map by executing a first machine-learning program, the first machine-learning program taking sensor data from an imaging sensor as input, the anomaly map including a set of likelihood values at respective pixel locations, each likelihood value representing a probability that an anomaly of any type is present at the respective pixel location; and
classify an anomaly in the sensor data as a specific type by executing a second machine-learning program, the second machine-learning program taking the anomaly map as input.

2. The computer of claim 1, wherein the imaging sensor is mounted to a vehicle, and the instructions further include instructions to actuate a component of the vehicle based on the specific type of the anomaly.

3. The computer of claim 1, wherein the imaging sensor is mounted to a vehicle, and the instructions further include instructions to actuate a component of the vehicle based on a location of the anomaly as indicated by the anomaly map.

4. The computer of claim 1, wherein the first machine-learning program is trained on a set of training sensor data with binary labels indicating whether an anomaly is present or absent.

5. The computer of claim 4, wherein each binary label applies to the respective training sensor data recorded at a specific timestep as a whole.

6. The computer of claim 4, wherein the set of training sensor data is a first set of first training sensor data, and the first machine-learning program is trained on a second set of second training sensor data with labels indicating pixel locations of anomalies.

7. The computer of claim 6, wherein the first set is a majority of training data used to train the first machine-learning program.

8. The computer of claim 1, wherein the instructions to classify the anomaly include instructions to select the specific type from a predetermined set of potential specific types.

9. The computer of claim 8, wherein each likelihood value in the anomaly map represents the probability that an anomaly of at least one of the potential specific types is present at the respective pixel location.

10. The computer of claim 8, wherein the potential specific types are types of occlusions.

11. The computer of claim 8, wherein an output of the second machine-learning program is an anomaly-type map, the anomaly-type map including a set of likelihood vectors at respective pixel locations, each likelihood vector including a plurality of entries, each entry representing a probability that an anomaly of one of the respective potential specific types is present at the respective pixel location.

12. The computer of claim 1, wherein the instructions further include instructions to determine an anomaly score for the anomaly map, and, in response to the anomaly score exceeding a threshold, classify the anomaly as the specific type by executing the second machine-learning program.

13. The computer of claim 1, wherein the first machine-learning program includes a fully convolutional data description.

14. The computer of claim 1, wherein the first machine-learning program includes at least one up-sampling layer.

15. The computer of claim 1, wherein the imaging sensor is a camera, and the sensor data is an image.

16. A method comprising:
generating an anomaly map by executing a first machine-learning program, the first machine-learning program taking sensor data from an imaging sensor as input, the anomaly map including a set of likelihood values at respective pixel locations, each likelihood value representing a probability that an anomaly of any type is present at the respective pixel location; and
classifying an anomaly in the sensor data as a specific type by executing a second machine-learning program, the second machine-learning program taking the anomaly map as input.

17. The method of claim 16, wherein the imaging sensor is mounted to a vehicle, the method further comprising actuating a component of the vehicle based on at least one of the specific type of the anomaly or a location of the anomaly as indicated by the anomaly map.

18. The method of claim 16, wherein the first machine-learning program is trained on a set of training sensor data with binary labels indicating whether an anomaly is present or absent.

19. The method of claim 16, wherein classifying the anomaly includes selecting the specific type from a predetermined set of potential specific types, an output of the second machine-learning program is an anomaly-type map, the anomaly-type map including a set of likelihood vectors at respective pixel locations, each likelihood vector including a plurality of entries, each entry representing a probability that an anomaly of one of the respective potential specific types is present at the respective pixel location.

20. The method of claim 16, wherein the first machine-learning program includes a fully convolutional data description followed by at least one up-sampling layer.
